(19) United States
(12) Patent Application Publication
(10) Pub. No.: US 2005/0053701 A1
(43) Pub. Date: Mar. 10, 2005

(54) Method for producing a pH enhanced meat product

(75) Inventor: Eldon Roth, Dakota Dunes, SD (US)

Correspondence Address: Russell D. Culbertson;The Culbertson Group, P.C., Suite 420, 1114 Lost Creek Boulevard, Austin, TX, 78746, US

(73) Assignee: Freezing Machines, Inc.

(21) Appl. No.: 10/951,076

(22) Filed: Sep. 27, 2004

Related U.S. Application Data
(63) Continuation-in-part of application No. 10/886,423, filed on Jul. 7, 2004.
Application No. 10/886,423 is a continuation of application No. 10/379,761, filed on Mar. 5, 2003.
(63) Continuation-in-part of application No. 10/269,531, filed on Oct. 11, 2002.

(51) Int. Cl. C12G 1/00

(52) U.S. Cl. 426/281

(57) ABSTRACT

A method for producing a pH enhanced meat product includes injecting or otherwise forcing a pH modifying material into the interior of the meat product, either before, after, or concurrently with an oxygen enhancing material. The oxygen enhancing material may be combined or mixed with the pH modifying material to form an oxygen enhanced pH modifying brine. This brine is then forced into the interior of the meat product to effect the desired pH modification in the meat product.

### CROSS-REFERENCE TO RELATED APPLICATIONS

This application is a continuation-in-part of U.S. patent application Ser. No. 10/886,423, filed Jul. 7, 2004, and entitled “Method and Apparatus for Injecting Liquids Into a Meat Product,” which is a continuation of U.S. patent application Ser. No. 10/379,761, filed Mar. 5, 2003, and entitled “Method for Modifying pH Within Meat Products.” This application is also a continuation-in-part of U.S. patent application Ser. No. 10/269,531 filed Oct. 11, 2002, and entitled “Method and Apparatus for Providing Improved Appearance and Shelf Life in Packed Meat Products.” The Applicant claims the benefit of each of these prior applications under 35 U.S.C. §120. The entire content of each of these prior applications is also incorporated herein by this reference.

### TECHNICAL FIELD OF THE INVENTION

This invention relates to meat processing systems in which fluids are injected into meat products. More particularly, the invention relates to methods for enhancing the pH of meat products by injecting pH modifying brines into the interior of the meat product.

### BACKGROUND OF THE INVENTION

Meat processing operations include a wide variety of processing steps for preparing meat products for consumers. After slaughter, the animal carcass is cleaned, chilled, and then passed on to trimming operations in which large cuts of meat such as steaks, roasts, and filets are separated from the carcass. Special processing steps may be applied to the material left after the initial trimming operations to recover additional lean meat from the trimmings.

One common treatment process applied particularly to larger cuts of meat involves injecting various liquids into the meat. The liquids may include flavor enhancing agents, microbe suppression agents, color enhancing agents, or liquids for otherwise imparting certain desired characteristics to the meat. Regardless of the purpose of the injected liquid, a liquid injected into a meat product is commonly referred to as a “brine.” It will be appreciated that the injected liquid or brine need not in fact include a salt or any other material in solution to qualify as a “brine” under this broad definition of the term.

### SUMMARY OF THE INVENTION

The present invention provides a method for producing a pH enhanced meat product by injecting or otherwise forcing a pH modifying material into the interior of the meat product. According to the invention, an oxygen enhancing material is injected or otherwise forced into the interior of the meat product either before, after, or concurrently with the pH modifying material.

In one preferred form of the invention, the oxygen enhancing material is combined or mixed with the pH modifying material to form an oxygen enhanced pH modifying brine. This brine is then forced into the interior of the meat product to effect the desired pH modification in the meat product. This preferred form of the invention effectively forces the oxygen enhancing material and the pH modifying material into the interior of the meat product concurrently through the same injection conduit.

An “oxygen enhancing material” as used in this disclosure and the accompanying claims comprises any material that makes oxygen available for incorporation in the meat product, particularly by binding with proteins in the meat product. A suitable oxygen enhancing material comprises oxygen or a mixture including oxygen, either in a gaseous state or dissolved in a suitable solvent for oxygen.

A “pH modifying material” as used in this disclosure and accompanying claims may comprise any suitable material that may be added to a meat product to modify the pH of the meat product. Preferred pH increasing materials include ammonia-based materials such as ammonium hydroxide, for example. A preferred pH decreasing material comprises a carbonic acid solution.

Because the invention involves forcing materials into the interior of a meat product, the methods are best suited for treating relatively large cuts of meat, such a steaks, chops, filets, and roasts, or larger carcass sections from which these cuts may be produced. The invention has application to meat products comprising beef, pork, lamb, mutton, poultry, and fish.

The present invention of forcing both a pH modifying material and an oxygen enhancing material into the interior of a meat product has been found to produce superior color in the meat product. This superior color is obtained without producing the rancidity that may be associated with over exposure of fatty tissues to oxygen.

These and other advantages and features of the invention will be apparent from the following description of the preferred embodiments, considered along with the accompanying drawings.

### BRIEF DESCRIPTION OF THE DRAWINGS

FIG. 1 is a diagrammatic representation of a treatment system embodying the principles, of the present invention.

FIG. 2 is a diagrammatic representation of an injection apparatus that may be used to perform methods embodying the principles of the invention.

FIG. 3 is an enlarged section view showing an end portion of an injection conduit that may be used in the apparatus shown in FIG. 2.

FIG. 4 is a section view similar to FIG. 3, but showing an alternate injection conduit structure.

### DESCRIPTION OF PREFERRED EMBODIMENTS

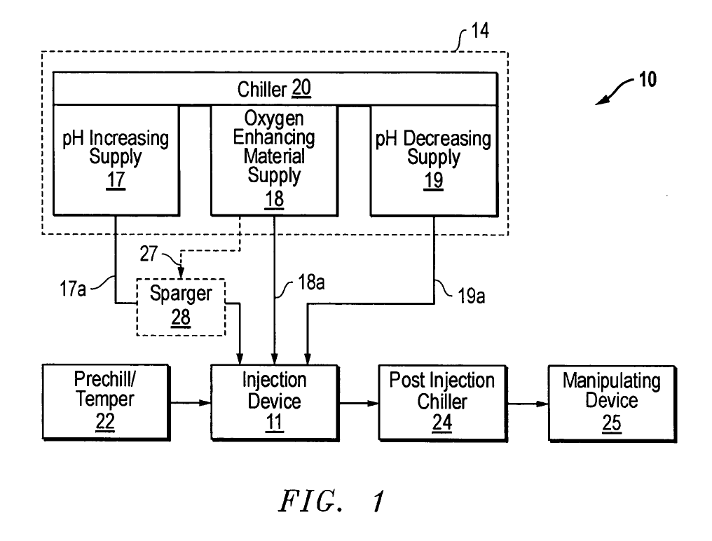

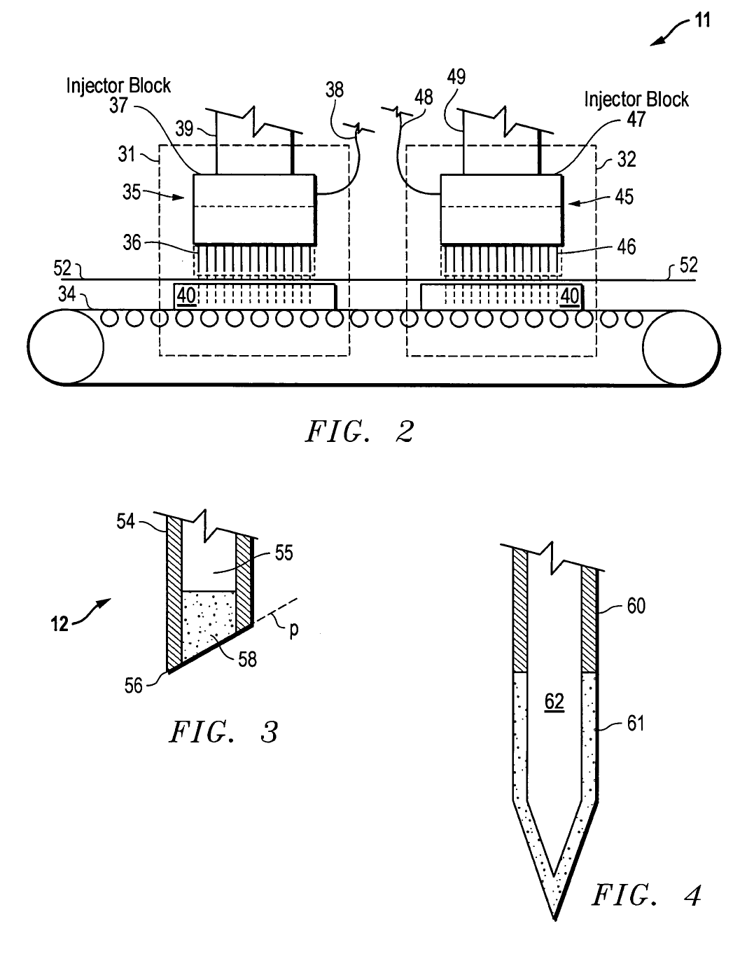

The system 10 shown diagrammatically in FIG. 1 may be used to describe treatment methods embodying the principles of the present invention. FIG. 2 shows further details of an injection device 11 that may be used in performing certain steps of the invention, while FIGS. 3 and 4 show alternate injection conduits or needles that may be used in the present treatment methods.

Referring to FIG. 1, treatment system 10 includes injection device 11 connected to receive treatment materials from a treatment material supply arrangement 14. The illustrated treatment material supply arrangement 14 in FIG. 1 includes three separate material supplies, a supply 17 of pH increasing material, an oxygen enhancing material supply 18, and a supply 19 of pH decreasing material. Treatment system 10 also includes one or more chilling or temperature control devices that together make up a temperature control arrangement for the meat product being treated in the system. The diagrammatic example system 10 shown in FIG. 1 includes two separate devices that make up the temperature control arrangement, a prechilling device 22 and post-injection chiller 24. Treatment system 10 further includes a manipulating device 25 positioned to receive meat products after the desired injection of treatment materials.

It will be appreciated that the system shown in FIG. 1 is shown only for purposes of example, and is not intended to limit the present invention to any particular arrangement of devices or any particular treatment or injection materials. In particular, the present invention has application with any suitable oxygen enhancing material and with any pH modifying material or materials. Also, it should be appreciated that the oxygen enhancing material may comprise any number of different materials within the scope of the present invention. For example, the oxygen enhancing material may comprise substantially pure oxygen gas or oxygen gas mixed with other suitable gasses that may be used in meat processing including noble gasses, inert gasses such as nitrogen for example, and carbon monoxide gas, or mixtures of any of these gasses. However, as will be described in further detail below, the oxygen enhancing material is preferably not injected directly into the meat product as a gas. Rather, the oxygen enhancing material may be dissolved in a suitable solvent and then injected into the meat product in this dissolved form.

Injection device 11 operates to inject the desired oxygen enhancing material and pH modifying material or materials into the interior of a meat product held in the device. The injection will commonly require inserting an injection conduit or needle into the interior of the meat product to an inserted position. In this inserted position, a fluid communication structure or opening in the injection conduit is positioned within the interior of the meat product so that the desired treatment material may be forced through the conduit and into the interior of the meat product. Both the oxygen enhancing material and pH modifying material are injected preferably into soft tissue in the meat product, such as muscle or other soft tissue. Further detail regarding injection device 11 will be described below with reference to FIG. 2.

Each of the material supplies 17, 18, and 19 may include a suitable vessel for containing a supply of the desired material. For example, pH increasing material supply 17 may include a vessel containing ammonia gas or aqueous ammonium (ammonium hydroxide solution). To facilitate some forms of the invention, two separate vessels may be used for pH increasing material supply 17, each separate vessel storing a different pH increasing material. In any event, pH increasing material supply 17 is connected to injection device 11 with at least one suitable connection line or conduit 17a to supply the desired material or materials to the injection device to be injected into the meat being treated in the system. It will be appreciated that the material to be injected must be forced into the meat being treated under a suitable driving pressure. The pH increasing material may be pressurized at supply 17, at injection device 11, or by a suitable device connected between supply 17 and injection device 11 in order to provide the required injection force.

pH decreasing material supply 19 may include a vessel suitable for containing a pH deceasing material such as carbon dioxide gas or carbon dioxide in solution with water (carbonic acid solution). As with pH increasing material supply 17, the supply 19 may in fact include more than one vessel with each vessel containing a different pH decreasing material. Regardless of the number of vessels which make up supply 19, the supply is connected by one or more suitable conduits or lines 19a to supply the material or materials to injection device 11. The driving force for forcing the pH decreasing material or materials into the meat product being treated may be provided in any of the ways described above with reference to the pH increasing material supply 17.

Oxygen enhancing material supply 18 may include a vessel or multiple vessels containing any suitable material that may be used with the particular pH modifying material or materials to be injected. A suitable connection conduit or line 18a connects oxygen enhancing material supply 18 to injection device 11. As with the other material supplies 17 and 19, the force for driving the gas into the meat product may be provided from the supply itself, at the injection device 11, or using a suitable pumping device connected in the supply line 18a extending from supply 18 to injection device 11.

It will be appreciated that although three separate connection lines are shown in FIG. 1 from supplies 17, 18, and 19, some forms of the invention may include a manifold capable of switching between the different supplies. Such a manifold would receive inputs from each material supply and include a suitable arrangement of valves for switching between these inputs and provide an output directed to injection device 11. The present invention is not limited by any particular structural arrangement for supplying the desired pH modifying materials and oxygen enhancing materials to injection device 11 for injection into the meat products being treated.

Although the supplies 17, 18, and 19 are described above as each being connected by a separate connecting line or flow path the injection device 11, some preferred forms of the present invention may combine the oxygen enhancing material with one of the pH modifying materials for injection into the meat product. To illustrate this alternative, FIG. 1 shows dashed line 27 extending from oxygen enhancing material supply 18 to a combining device 28 associated with line 17a from pH increasing material supply 17a. This line 27 would be used in lieu of line 18a. In one preferred form of the invention, combining device 28 includes a suitable sparger for sparging the oxygen enhancing material from supply 18 into a stream of pH increasing material. For example, pH increasing material supply 17 may include a supply of ammonia gas and a supply of water with a sparging device for sparging the ammonia gas into a stream of water to produce an ammonium hydroxide solution carried to injection device 11 through line 17a. In this example, an oxygen enhancing material such as oxygen gas from supply 18 may be sparged into the ammonium hydroxide solution through sparging device 28 to product an oxygen enhanced pH increasing brine. This oxygen enhanced pH increasing brine is supplied to injection device 11 where it is injected into the meat product. Alternative arrangements may combine the oxygen enhancing material with the makeup water used to produce the ammonium hydroxide solution or may combine the ammonia gas and oxygen enhancing material first and then sparge the mixture of gasses into the makeup water through a single sparging device.

Injection fluid temperature control device 20 shown in FIG. 1 operates to control the temperature of the treatment material injected into the meat products through injection device 11. The nature of temperature control device 20 will depend upon the nature of the material being injected. In some forms of the treatment system, temperature control device 20 may comprise a chiller through which the different materials from supplies 17, 18, and/or 19 may be circulated to maintain the materials at the desired temperatures. Temperature control device 20 may comprise a single chilling device for chilling materials from each of the supplies 17, 18, and 19, or separate chilling devices for each supply.

Prechiller device 22 shown in FIG. 1, operates to place the meat products at the desired process temperatures employed in the treatment methods according to the present invention. The single device shown as prechiller 22 may actually include a number of separate refrigerating devices. For example, a prechiller may include a freezer for reducing the temperature of the meat products to a temperature well below the initial and final freezing temperature of the meat products, and then one or more separate tempering devices for tempering the meat product to a temperature at or just above or below the initial freezing temperature of the meat product. Alternatively, a single prechilling device 22 may place the meat products at the desired temperature for performing the material injection or injections according to the present invention.

Post-injection chiller 24 may be included in treatment system 10 for controlling the temperature of the meat products after injection with the desired materials in injection device 11. Post-injection chiller 24 may be placed before any manipulating device included in the system, such as manipulating device 25 as shown, or after the manipulating device in the process flow. In any case, post-injection chiller 24 may include any suitable refrigerating device for controlling the temperature of the injected meat products within the desired temperature range. This range may include temperatures well below the initial and final freezing temperature of the meat being treated.

Manipulating device 25 is arranged to receive meat products after they have been injected with the desired materials in injection device 11. The device may include a massaging device or tumbler for physically working the meat products to help distribute the pH modifying and oxygen enhancing materials throughout the interior of the meat products. Manipulating device 25 may alternatively include a chamber in which the injected the products are subjected to elevated pressures. It will be appreciated that in systems 10 in which the meat is frozen when it leaves injection device 11, manipulation of the meat product may be undesirable in some situations, and thus the manipulating device may be omitted from the system. However, some manipulation in the meat product may be desirable even if the meat product is in a frozen or partially frozen state.

Referring now to FIG. 2, a suitable injection device 11 may include two separate injection stations shown at dashed boxes 31 and 32, and a conveyor 34 for conveying meat products through the device. First injection station 31 includes a first injector 35 having a number of injection conduits or needles 36 extending from a common supply block 37 which is connected to a treatment material supply line 38. It will be appreciated that supply block 37 includes fluid passages that direct treatment fluid from the supply line 38 to the injection conduits 36. Supply block 37 is mounted on a manipulating structure 39 that may be operated to move the block 37 from an upper position shown in solid lines to a lower or injection position shown in phantom lines, and then back to the upper position. In the injection position of block 37, injection conduits 36 are pressed into the meat product 40 to the injection position in which the desired treatment material may be injected into the interior of the meat product.

Second injection station 32 includes a second injector 45 having injection conduits or needles 46 depending from a supply block 47. A second supply line 48 connects to block 47 for supplying treatment material to the block to be distributed through fluid passages in the block to injection conduits 46. As with the first injector 35, second injector 45 is connected to a manipulating structure 49 which may be operated to move block 47 and injection conduits 46 between an upper position shown in solid lines and a lower, injection position shown in phantom lines. In the injection position, injection conduits 46 are pressed into the meat product 40 to an injection position in which the desired treatment material may be injected through the injection conduits into the interior of meat product.

Both sets of injection conduits or needles 36 and 46 extend through openings in a plate 52. Plate 52 defines an upper boundary for the path the meat products 40 take through injection device 11. This upper boundary separates the meat products 40 from the upper components of injection device 11. The upper boundary provided by plate 52 also helps define an area or tunnel in the injection device 11 that helps isolate the meat products being treated so as to help maintain the temperature of the meat products as they pass through injection device 11.

In operation, the meat product 40 to be treated is first conveyed to first station 31 and to a position immediately beneath injection conduits 36 carried by injection block 37. Meat product 40 is held in this position while injection block 37 and injection conduits 36 are lowered on manipulating structure 39 until the injection conduits 36 reach an inserted position in which the distal ends of conduits 36 extend into the interior of meat product 40. In this inserted position, an opening or fluid communication arrangement associated with each injection conduit 36 is positioned in the interior of meat product 40. Treatment material may then be pumped or otherwise forced through supply line 38, fluid passages in block 37, and the injection conduits 36 into the interior of meat product 40. After the desired amount of treatment material has been forced into the interior of meat product 40, the flow of treatment fluid through injection conduits 36 may be stopped and manipulating structure 39 operated to lift block 37 up to withdraw the injection conduits from meat product 40. With injection conduits 36 withdrawn from meat product 40, conveyor 34 may be driven with a suitable drive (not shown) to move the meat product to second station 32. Injector 45 at second station 32 may be operated similarly to injector 35 to inject additional treatment fluid into meat product 40. Once any second or additional injection is complete, meat product 40 may then be conveyed out of injection device 11.

It will be appreciated that the injection conduits 36 and 46 may not be maintained in a static inserted position in the meat product 40 while material is injected. Some injection conduits, especially those that inject only through an end of the conduit, may be manipulated to different inserted positions in the meat product by the respective manipulating structure in order to allow the treatment material to be injected at different depths in meat product 40.

The supply conduits 38 and 48 to the two injectors 35 and 45, respectively, may each be connected to a respective single supply of treatment material. For example, the first injector 35 may be used to inject an ammonia-based pH modifying material such as aqueous ammonia. Second injector 45 may be used to inject an oxygen enhancing material according to the invention and/or a pH deceasing material such as carbon dioxide gas or carbonic acid solution. Alternatively, first injector 35 may be used to inject an oxygen enhancing material according to the invention while second injector 45 may be used to inject a pH modifying brine or gas. Also, alternatively to the fixed supply arrangement, each supply conduit 38 and 48 may be connected to a number of supplies for different types of treatment materials controlled through a suitable manifold (not shown). This multiple supply connection allows for example, a gas such as nitrogen to be injected first into a meat product and then an oxygen enhanced pH modifying brine through the same injection conduits. As yet another alternative, an oxygen enhancing material may be injected through first injector 35 and different brines may be injected through second injector 45 or even a third or further subsequent injector (not shown in FIG. 2). Regardless of the number of injectors used in a system and regardless of the number of different brines or other pH modifying materials used, an oxygen enhancing material may also be injected according to the invention as the final material injected after injections of one or more pH modifying materials.

FIG. 3 provides an enlarged section view of a distal end of a preferred structure for injection conduits 36 and 46 shown in FIG. 2. The injection conduit includes a tube portion 54 having an opening 55 extending there through. The tube 54 terminates at an end defined by a plane P extending at a steep angle to the longitudinal axis of the tube. This structure provides a sharp pointed end 56 to the injection conduit. Although the end of tube 54 may simply be left open to provide a fluid communication arrangement for allowing treatment fluid to flow through the injection conduit, the illustrated injection conduit includes a plug of porous and permeable material 58 positioned in tube opening 55 at the end of the tube 54. This porous and permeable material is cut along the same plane P as the tube, and facilitates better control of fluid flow through tube opening 55 into the meat product. Examples of suitable porous and permeable materials include sintered metals such as the sintered materials produced by Mott Corporation of Farmington Connecticut.

FIG. 4 shows an alternate injection conduit that may be used in the present invention. In this alternate structure, the injection conduit includes a base tube portion 60 and an injection tube portion 61. At least a portion of the injection tube portion 61 is made up of porous and permeable material such as the material shown at 58 in FIG. 3. The material to be injected flows from the interior 62 of injection tube portion 61 through the porous and permeable material of fluid communication structure. This alternative injection conduit and fluid communication structure has the advantage that the pH modifying material flows into the meat all along the porous and permeable material, which, as shown in FIG. 4, may extend far up the side of the conduit. This ability of the pH modifying material to flow into the meat through essentially the sides of the injection conduit allows the material to be injected at different depths in the meat without having to adjust the depth to which the conduit is inserted into the meat.

The injection conduit structure shown in FIG. 4 includes a conical pointed end 64 to facilitate inserting the conduit into the meat product to be treated. This type of pointed end is shown only for purposes of example. Alternate forms of injection conduits having porous and permeable side sections may be formed with a steeply angled planar end similar to the planar end of the conduit shown in FIG. 3. Also, other forms of the injection conduit may include a solid material tip or point and porous and permeable material along the sides of the conduit or portions of the conduit.

Preferred methods of treating meat products may be described with reference to the apparatus shown in FIGS. 1 and 2. One preferred treatment method includes inserting the injection conduits 36 or 46 shown in FIG. 2 into meat product 40 to the inserted position described above. The method then includes forcing oxygen enhancing material through the injection conduits 36 or 46 into the interior of meat product 40. Once the desired amount of oxygen enhancing material has been injected an ammonia-based pH modifying material may be forced into the interior of the meat product either through the same injection conduits or others. Alternatively, the oxygen enhancing material and pH modifying material may be combined so that oxygen is dissolved in the pH modifying material (such as an ammonium hydroxide solution or carbonic acid solution) and the resulting oxygen enhanced pH modifying material may be injected through the injection conduits 36 and/or 46 in FIG. 2. Where a pH increasing material is used, a sufficient amount of the material may be forced into the interior of meat product 40 to increase the pH at one or more points within the interior of the meat product to a pH of approximately 6.0 and perhaps to as high as 7.5 or higher.

It will be appreciated that the amount of pH modifying material required to produce the desired final pH in the meat product will depend upon a number of factors including the concentration of the pH modifying material, the initial pH of the meat product, and the temperature of the meat product. Ammonium hydroxide solutions having a pH from 8.0 to 12.0 may be used to produce the desired pH change in the meat.

After or before injecting the pH modifying material into the interior of meat product 40, the present invention may also include the step of forcing a pH decreasing material into the interior of the meat product. This pH decreasing material, such as carbon dioxide gas or carbon dioxide in solution with water, may be injected through the same injection conduits 36 used to inject the ammonia-based pH modifying material. Alternatively, the treatment method may include inserting the second injection conduits 46 into the meat product 40 to the inserted position and the step of forcing the pH decreasing material into the interior of the meat product may then be accomplished through this second set of injection conduits or needles 46.

The above described preferred embodiments are intended to illustrate the principles of the invention, but not to limit the scope of the invention. Various other embodiments and modifications to these preferred embodiments may be made by those skilled in the art without departing from the scope of the following claims.

1. A method including:
(a) forcing an oxygen enhancing material into an interior of a meat product through an injection conduit positioned within the meat product; and
(b) forcing a pH modifying material into the interior of the meat product through the injection conduit or through an additional injection conduit.

2. The method of claim 1 wherein the oxygen enhancing material comprises a gas including oxygen gas.

3. The method of claim 1 wherein the pH modifying material comprises an ammonia-based pH modifying material and forcing the pH modifying material into the interior of the meat product increases the pH at one or more points within the interior of the meat product to a pH above approximately 6.0.

4. The method of claim 3 further including forcing a pH decreasing material into the interior of the meat product.

5. The method of claim 1 wherein the pH modifying material comprises a pH decreasing material.

6. The method of claim 1 wherein the oxygen enhancing material is forced into the interior of the meat product prior to forcing the pH modifying material into the interior of the meat product.

7. The method of claim 1 wherein the oxygen enhancing material is forced into the interior of the meat product after forcing the pH modifying material into the interior of the meat product.

8. The method of claim 1 wherein the oxygen enhancing material is forced into the interior of the meat product concurrently with forcing the pH modifying material into the interior of the meat product.

9. The method of claim 8 further including:
(a) combining the oxygen enhancing material with the pH modifying material to product an oxygen enhanced pH modifying brine; and
(b) wherein the oxygen enhancing material and pH modifying material are forced into the interior of the meat product concurrently by forcing the oxygen enhanced pH modifying brine into the interior of the meat product.

10. A method including:
(a) inserting an injection conduit in a meat product so as to position a fluid communication structure associated with the injection conduit within a soft tissue mass of the meat product;
(b) forcing an oxygen enhancing material into the interior of the meat product through the fluid communication structure; and
(c) forcing a pH modifying material into the interior of the meat product through the injection conduit or through an additional injection conduit.

11. The method of claim 10 wherein the pH modifying material comprises an ammonia-based pH modifying brine.

12. The method of claim 11 further including forcing a pH decreasing material into the interior of the meat product.

13. The method of claim 10 wherein the pH modifying material comprises a pH decreasing material.

14. The method of claim 10 wherein the oxygen enhancing material is forced into the interior of the meat product prior to forcing the pH modifying material into the interior of the meat product.

15. The method of claim 10 wherein the oxygen enhancing material is forced into the interior of the meat product after forcing the pH modifying material into the interior of the meat product.

16. The method of claim 10 wherein the oxygen enhancing material is forced into the interior of the meat product concurrently with forcing the pH modifying material into the interior of the meat product.

17. The method of claim 16 further including:
(a) combining the oxygen enhancing material with the pH modifying material to product an oxygen enhanced pH modifying brine; and
(b) wherein the oxygen enhancing material and pH modifying material are forced into the interior of the meat product concurrently by forcing the oxygen enhanced pH modifying brine into the interior of the meat product.

18. A method including:
(a) forcing an oxygen enhancing material including oxygen gas into an interior of a meat product through an injection conduit positioned within the meat product; and
(b) forcing a pH modifying brine into the interior of the meat product through the injection conduit or through an additional injection conduit, the pH modifying brine including an ammonia-based pH modifying material and increasing the pH of the meat product at one or more points in the interior of the meat product to a pH of approximately 6.0 or more.

19. The method of claim 18 wherein the oxygen enhancing material is forced into the interior of the meat product prior to forcing the pH modifying brine into the interior of the meat product.

20. The method of claim 18 wherein the oxygen enhancing material is forced into the interior of the meat product after forcing the pH modifying brine into the interior of the meat product.

21. The method of claim 18 wherein the oxygen enhancing material is forced into the interior of the meat product concurrently with forcing the pH modifying brine into the interior of the meat product.

22. The method of claim 18 further including:
(a) combining the oxygen enhancing material with the pH modifying material to product an oxygen enhanced pH modifying brine; and
(b) wherein the oxygen enhancing material and pH modifying material are forced into the interior of the meat product concurrently by forcing the oxygen enhanced pH modifying brine into the interior of the meat product.
